(19) United States
(12) Patent Application Publication
(10) Pub. No.: US 2025/0149823 A1
(43) Pub. Date: May 8, 2025

(54) CONNECTOR

(71) Applicant: YAZAKI CORPORATION, Tokyo (JP)

(72) Inventors: Sota Kawarasaki, Makinohara-shi (JP); Ryo Yamashita, Makinohara-shi (JP); Masaki Ota, Makinohara-shi (JP)

(21) Appl. No.: 18/908,730

(22) Filed: Oct. 7, 2024

(30) Foreign Application Priority Data
Nov. 8, 2023 (JP) 2023-190862

(51) Int. Cl. H01R 13/52; H01R 13/506

(52) U.S. Cl. CPC H01R 13/5202; H01R 13/506

(57) ABSTRACT

There is provided a connector including: a housing having a fitting portion to be fitted to a counterpart connector; a cover assembled to an opening opposite to the fitting portion; an annular seal member sealing a gap between an inner peripheral side seal surface of the opening and an outer peripheral side seal surface of the cover; and a plurality of reinforcing ribs disposed at predetermined intervals along an inner peripheral surface of the housing and extending along an assembling direction of the cover. When the cover is assembled to the opening, an end in an extension direction of the reinforcing ribs on an opening end side of the opening faces the seal member, thereby preventing the seal member from falling off from the inner peripheral side seal surface and the outer peripheral side seal surface.

### CROSS-REFERENCE TO RELATED APPLICATIONS

This application is based on and claims priority under 35 USC 119 from Japanese Patent Application No. 2023-190862 filed on Nov. 8, 2023, the contents of which are incorporated herein by reference.

### TECHNICAL FIELD

The present disclosure relates to a connector.

### BACKGROUND ART

In the related art, as disclosed in, for example, JP2014-086150A, JP2015-082466A, and JP2022-002194A, a connector attached to a case of a device includes a housing made of synthetic resin and formed in a substantially L shape. The housing includes a fitting portion that accommodates a terminal connected to an end of an electric wire and is fitted to a device-side connector (counterpart connector), and an electric wire introduction portion into which the electric wire connected to the terminal is introduced from a direction intersecting a fitting direction of the fitting portion. The housing has a working hole (opening) on an opposite side to the fitting portion, and a cover is attached to the working hole.

A seal ring (annular seal member) in close contact with an inner peripheral surface (inner peripheral side seal surface) of the working hole to seal the inside of the housing is assembled to an outer peripheral side seal surface of the cover. The cover is attached to the working hole so as not to allow water or the like to enter the housing from the working hole. That is, the seal ring seals a gap between the inner peripheral side seal surface of the working hole and the outer peripheral side seal surface of the cover.

When the inner peripheral side seal surface of the working hole of the housing is creep-deformed outward by a reaction force of the seal member under the high-temperature environment, the sealing pressure may decrease. Therefore, in the related art, deformation of the housing is prevented by providing a plurality of deformation prevention ribs in the housing.

When an internal pressure is applied to the inside of the housing under the high-temperature environment, the seal member may fall off the inner peripheral side seal surface of the working hole and the outer peripheral side seal surface of the cover. In the related art, a through hole is formed in the cover, and a locking projection having a head portion of a diameter larger than a diameter of the through hole is provided on the seal member, thereby preventing the seal member from falling off the cover.

However, in order to prevent the seal member from falling off, providing the through hole of the cover and the locking projection of the seal member leads to an increase in size of the connector, and the connector is desired to be reduced in size.

### SUMMARY OF INVENTION

The present disclosure provides a compact connector capable of preventing deformation of a housing and preventing a seal member from falling off.

According to an illustrative aspect of the present disclosure, a connector includes: a housing having a fitting portion configured to be fitted to a counterpart connector; a cover assembled to an opening opposite to the fitting portion; an annular seal member configured to seal a gap between an inner peripheral side seal surface of the opening and an outer peripheral side seal surface of the cover; and a plurality of reinforcing ribs disposed at predetermined intervals along an inner peripheral surface of the housing and extending along an assembling direction of the cover, the inner peripheral surface of the housing being located behind the inner peripheral side seal surface of the opening. When the cover is assembled to the opening, an end in an extension direction of the reinforcing ribs on an opening end side of the opening faces the seal member, thereby preventing the seal member from falling off from the inner peripheral side seal surface and the outer peripheral side seal surface.

According to the present disclosure, it is possible to provide a compact connector capable of preventing deformation of a housing and preventing a seal member from falling off.

The present disclosure has been briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a connector according to an embodiment of the present disclosure;

FIG. 2 is an exploded perspective view of the connector in FIG. 1;

FIG. 3 is a rear view of a housing illustrated in FIG. 2;

FIG. 4 is a cross-sectional view taken along a line IV-IV in FIG. 3;

FIG. 5 is an enlarged perspective view of a seal member illustrated in FIG. 2;

FIG. 6 is a perspective view illustrating an assembling procedure of the connector illustrated in FIG. 2;

FIG. 7 is a cross-sectional view taken along a line corresponding to the line IV-IV of FIG. 3 illustrating a state before a cover according to the present embodiment is assembled to a housing;

FIG. 8 is a cross-sectional view illustrating a state where the cover illustrated in FIG. 7 is assembled to the housing; and

FIG. 9 is an enlarged cross-sectional view of main parts in FIG. 8.

### DESCRIPTION OF EMBODIMENTS

Hereinafter, examples of an embodiment according to the present disclosure will be described with reference to the drawings.

### EMBODIMENT

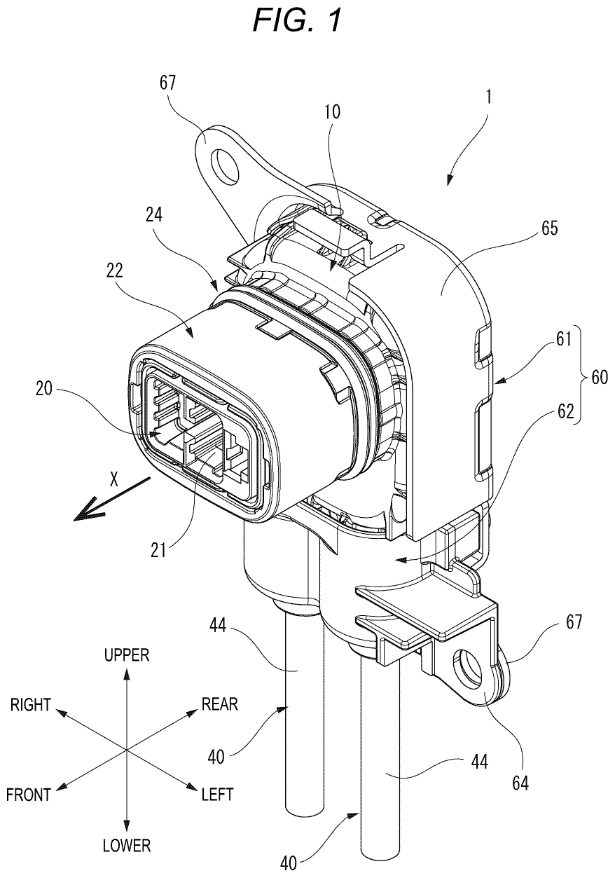

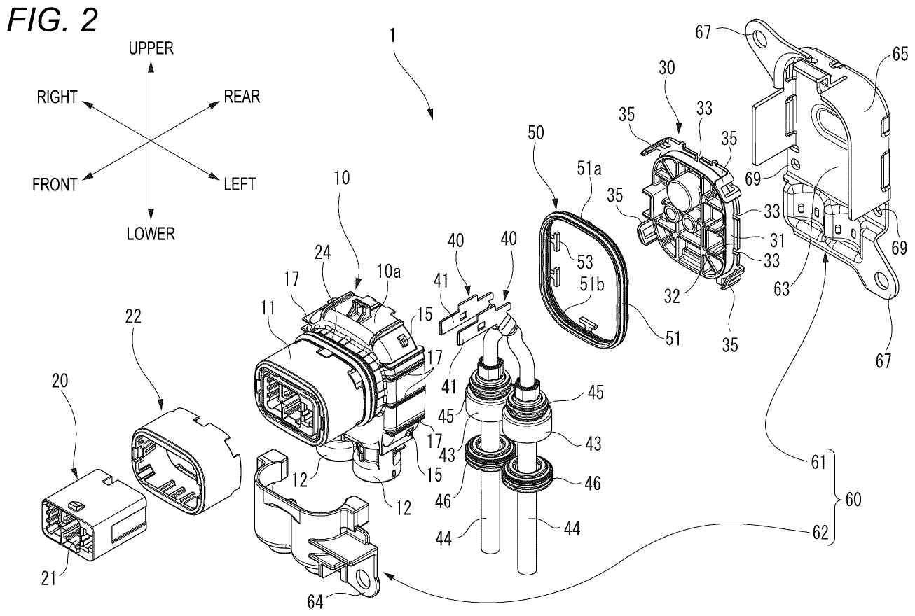

FIGS. 1 and 2 are a perspective view and an exploded perspective view of a connector 1 according to an embodiment of the present disclosure.

In the present specification, a front-rear direction, an up-down direction, and a left-right direction of the connector 1 follow directions of arrows in FIGS. 1 and 2. That is, the front-rear direction is a direction along a connector fitting direction of the connector 1, and a side to which a not-illustrated counterpart connector is fitted is referred to as a front side of a housing 10. The up-down direction is an extension direction of a shielded electric wire 44 orthogonal to the connector fitting direction of the connector 1, and a derivation direction of the shielded electric wire 44 is a downward direction. Further, the left-right direction is a longitudinal direction of a rectangular opening in a bottomed cylindrical fitting portion 11 orthogonal to the connector fitting direction.

As illustrated in FIGS. 1 and 2, the connector 1 according to the present embodiment includes the housing 10, two terminal-equipped electric wires 40, a cover 30, a seal member 50, and a shield shell 60. The connector 1 is, for example, a shielded connector used in a power supply circuit such as an inverter or a motor of a vehicle such as a hybrid vehicle or an electric vehicle. The connector 1 is fitted and electrically connected to a counterpart connector provided in a case such as an inverter or a motor.

As illustrated in FIGS. 2 to 4, the housing 10 is a housing formed in a substantially L shape, and includes a fitting portion 11 that accommodates tab terminals (terminals) 41 of the terminal-equipped electric wires 40 and is fitted to a device-side connector (counterpart connector), and electric wire introduction portions 12 that are introduced from a direction in which terminals of the shielded electric wires 44 connected to the tab terminals 41 intersect with a fitting direction X (see FIG. 1) of the fitting portion 11.

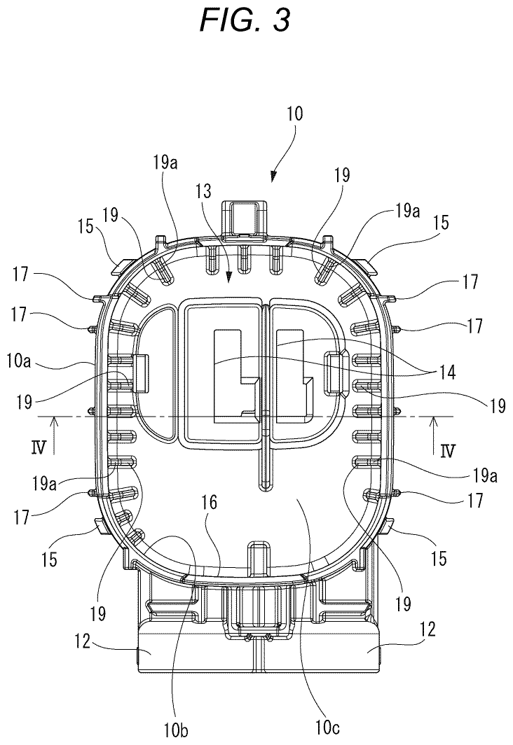

The fitting portion 11 is formed in a bottomed cylindrical shape having a rectangular opening, and protrudes forward in the fitting direction X of the housing 10 with the counterpart connector. A pair of terminal through holes 14 (see FIG. 3) is formed in a bottom portion of the fitting portion 11.

A packing 24 and a front holder 22 are assembled to an outer periphery of the fitting portion 11, and an inner housing 20 including a terminal accommodating chamber 21 is assembled to an inner periphery of the fitting portion 11.

Each electric wire introduction portion 12 extends in a downward direction that intersects with the fitting direction X of the housing 10 with the counterpart connector. Electric wire through holes (not illustrated) through which the shielded electric wires 44 are inserted are formed in the electric wire introduction portions 12.

A rear portion of the housing 10 opposite to the fitting portion 11 is an accommodating portion 13 formed in a concave shape open to an opening 16. The cover 30 is assembled to the opening 16 opposite to the fitting portion 11 in the rear portion of the housing 10. The housing 10 and the cover 30 are formed of synthetic resin having electrical insulation properties. When the cover 30 is assembled to the housing 10, the opening 16, which is an attaching working hole of the terminal-equipped electric wire 40, is covered with the cover 30.

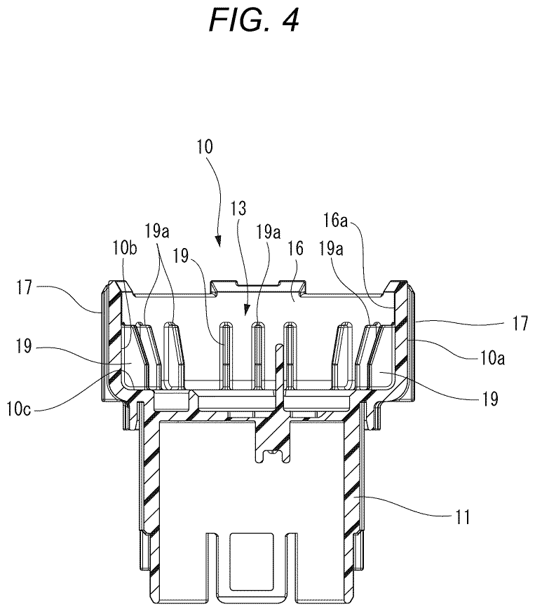

As illustrated in FIGS. 3 and 4, a plurality of ribs 17 are disposed along an outer peripheral surface 10a of the housing 10 corresponding to the outside of the opening 16. Each rib 17 is a protrusion having a rectangular cross-section extending along an assembling direction of an upper shield shell 61 to be described later. In addition, a plurality of locking claws 15 project from the outer peripheral surface 10a of the housing 10.

As illustrated in FIGS. 3 and 4, a plurality of reinforcing ribs 19 are disposed at an inside corner of the accommodating portion 13 to prevent deformation of the accommodating portion 13. The reinforcing ribs 19 are disposed at predetermined intervals along an inner peripheral surface 10b of the housing 10 located behind an inner peripheral side seal surface 16a of the opening 16, and extend along an assembling direction of the cover 30 (up-down direction in FIG. 4).

That is, each reinforcing rib 19 extends from a bottom surface 10c of the housing 10 toward an open end of the opening 16 along the inner peripheral surface 10b, and an end in an extension direction of the reinforcing rib 19 is located on the inner peripheral side seal surface 16a. The reinforcing rib 19 has a contact surface 19a on the end in the extension direction that is parallel to a width direction end surface 51c of a seal body portion 51 when the cover 30 is assembled to the opening 16.

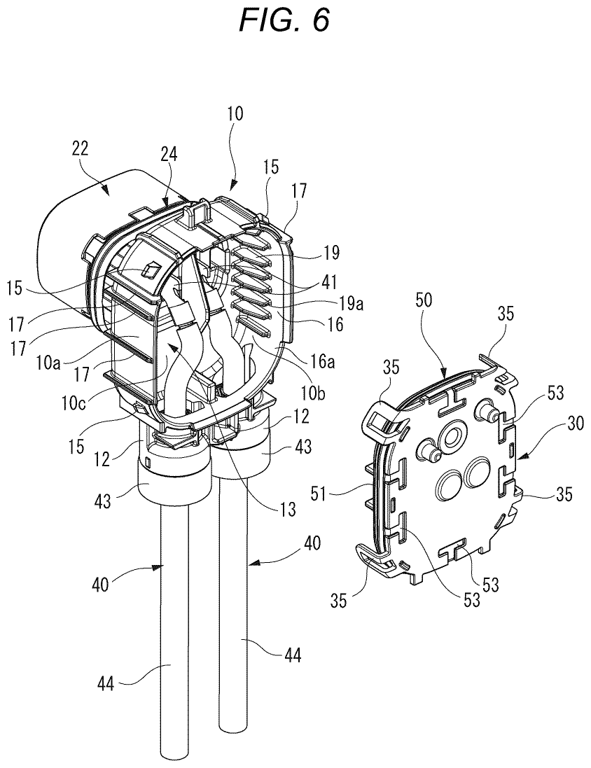

As illustrated in FIGS. 2 and 6, the cover 30 is formed in a substantially rectangular plate shape and is assembled to the opening 16 of the housing 10 from a rear side via the annular seal member 50.

The cover 30 includes an outer peripheral side seal surface 31 having an outer peripheral shape corresponding to the opening 16 of the housing 10 and onto which the seal member 50 is fitted, and a flange portion 32 projecting from a rear end of the outer peripheral side seal surface 31 in an assembling direction toward an outer diameter direction. The flange portion 32 restricts rearward movement of the seal member 50 fitted onto the outer peripheral side seal surface 31.

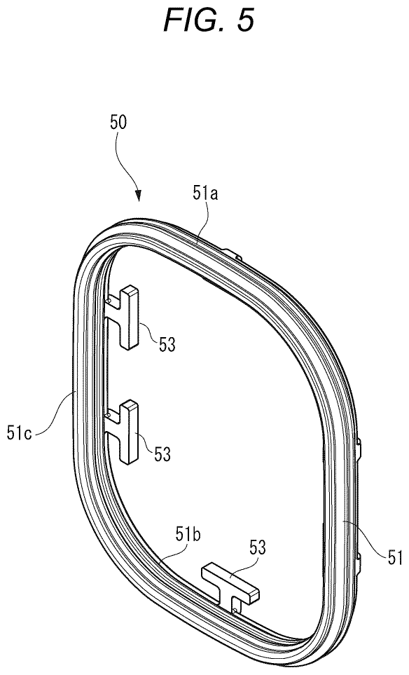

As illustrated in FIG. 5, the seal member 50 includes the seal body portion 51 formed in an annular shape by an elastic material such as rubber, and a plurality of T-shaped locking pieces 53 projecting toward a center from a rear end side of the seal body portion 51 in a fitting direction. Each of the T-shaped locking pieces 53 is formed in a T-shape in which a distal end portion thereof extends in the left-right direction.

An outer lip 51a is provided on an outer peripheral surface of the seal body portion 51 to be in close contact with the inner peripheral side seal surface 16a of the opening 16. An inner lip 51b is provided on an inner peripheral surface of the seal body portion 51 to be in close contact with the outer peripheral side seal surface 31 of the cover 30. Further, the width direction end surface 51c of the seal body portion 51 can face the contact surface 19a formed in the end in the extension direction of the reinforcing rib 19.

The seal member 50 is attached to the outer peripheral side seal surface 31 of the cover 30, and waterproofs and seals a gap between the opening 16 of the housing 10 and the cover 30. In the seal member 50, the T-shaped locking pieces 53 are locked to locking portion recesses 33 formed on an outer peripheral edge of the cover 30, thereby preventing the seal member 50 from falling forward inadvertently.

Accordingly, the opening 16 of the accommodating portion 13 of the housing 10 is sealed by the cover 30 in a watertight manner. A plurality of locking pieces 35 having locking holes are formed in a peripheral edge of the cover 30. The locking claws 15 formed in the housing 10 enter the locking holes of the locking pieces 35 by assembling the cover 30 to the housing 10. The locking pieces 35 are locked by the locking claws 15, and the cover 30 is held in an assembled state with respect to the housing 10.

As illustrated in FIG. 2, each terminal-equipped electric wire 40 includes the shielded electric wire 44, the tab terminal (terminal) 41 connected to a conductor terminal of the shielded electric wire 44, a shield terminal 43 connected to a braid of the shielded electric wire 44, and rubber plugs 45 and 46 for sealing a gap between the electric wire introduction portion 12 of the housing 10 and the shielded electric wire 44.

The shielded electric wire (electric wire) 44 is configured as a coaxial cable including a core wire disposed from a center thereof, an inner coating covering the core wire, a conductive braid covering the inner coating, and an outer sheath covering the braid.

The tab terminal 41 is formed of, for example, a conductive metal material such as copper, a copper alloy, aluminum, or an aluminum alloy. The tab terminal 41 is crimped to the core wire exposed at a terminal of the shielded electric wire 44 and is electrically connected to the shielded electric wire 44.

The tab terminal 41 is inserted into and electrically connected to an electrical connection portion of a counterpart terminal (not illustrated) provided in the counterpart connector.

In the terminal-equipped electric wire 40 assembled to the housing 10, the shielded electric wires 44 are inserted into the electric wire through holes of the electric wire introduction portions 12, and the tab terminals 41 are inserted into terminal through holes 14 of the fitting portion 11 and are accommodated in the terminal accommodating chamber 21 of the inner housing 20. Thus, the tab terminals 41 of the terminal-equipped electric wires 40 are fixed to the fitting portion 11 of the housing 10.

The rubber plugs 45 and 46 are attached to the shielded electric wires 44 of the terminal-equipped electric wire 40. The rubber plug 45 seals a gap between the shield terminal 43 connected to the braid of the shielded electric wire 44 and the electric wire introduction portion 12. The rubber plug 46 seals a gap between the shielded electric wire 44 and the shield terminal 43. The rubber plugs 45 and 46 seal a gap between the shielded electric wire 44 and the electric wire introduction portion 12.

As illustrated in FIG. 2, the connector 1 according to the present embodiment includes the shield shell 60 including an upper shield shell 61 assembled from a rear side of the housing 10 and a lower shield shell 62 assembled from a lower side. The upper shield shell 61 and the lower shield shell 62 are each made of a conductive metal material.

The upper shield shell 61 is formed in a box shape having a substantially rectangular flat bottom plate portion 63 and a peripheral wall 65 erected on a peripheral edge of the bottom plate portion 63. The bottom plate portion 63 covers a rear surface of the housing 10, and the peripheral wall 65 covers an upper surface and left and right side surfaces (side surfaces) of the housing 10. The upper shield shell 61 is provided with a through hole 69 and fixing pieces 67 in which hole portions are formed.

The lower shield shell (shield shell) 62 covers a portion on a front surface of the housing 10 excluding the fitting portion 11. The lower shield shell 62 is provided with screw holes (not illustrated) and fixing pieces 64 in which hole portions are formed.

Next, a case of assembling the connector 1 according to the present embodiment will be described.

First, as illustrated in FIG. 6, after the shielded electric wires 44 of the terminal-equipped electric wires 40 are passed through the electric wire introduction portions 12 of the housing 10 and the tab terminals 41 are pulled out toward the accommodating portion 13, the tab terminals 41 are inserted into the terminal through holes 14 of the housing 10.

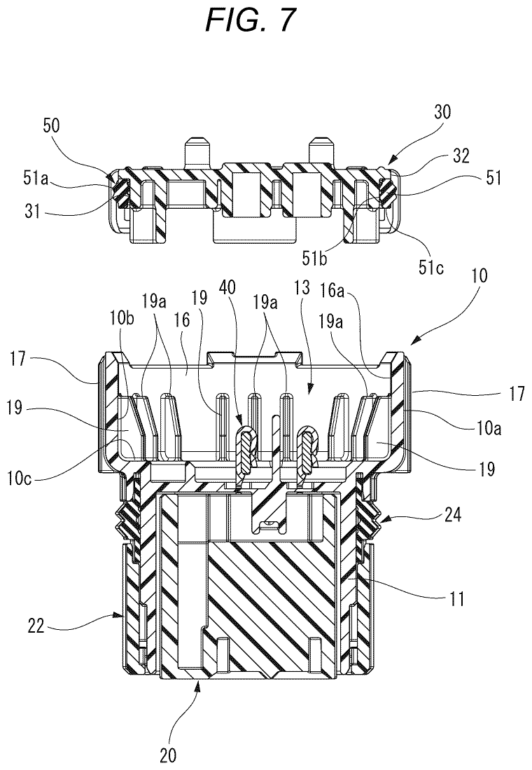

As illustrated in FIG. 7, the cover 30 is brought close to the accommodating portion 13 of the housing 10 to cover the opening 16 from a rear side, and the locking claws 15 of the housing 10 are locked to the locking pieces 35 of the cover 30.

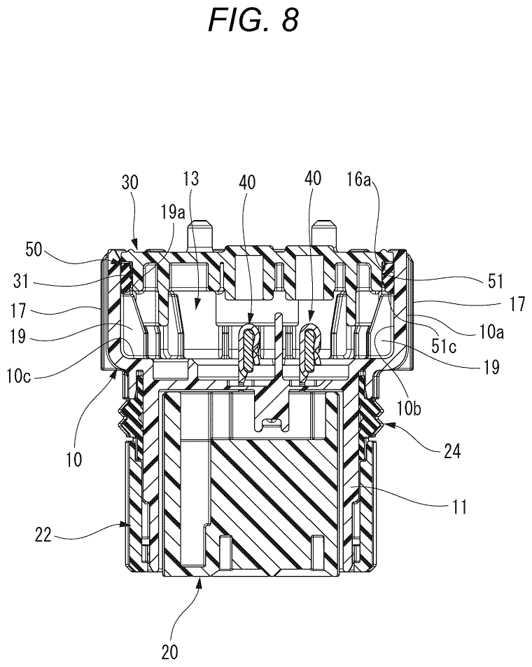

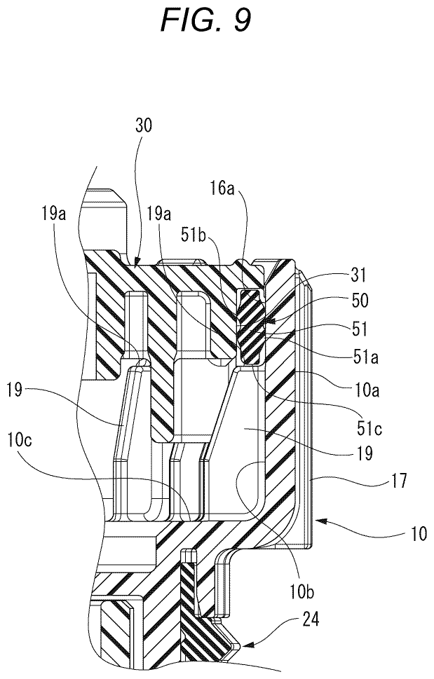

Thus, as illustrated in FIGS. 8 and 9, in the seal member 50 attached such that the inner lip 51b is in close contact with the outer peripheral side seal surface 31 of the cover 30, the outer lip 51a is in close contact with the inner peripheral side seal surface 16a of the opening 16. Thus, the seal member 50 attached to the housing 10 can waterproof and seal a gap between the opening 16 of the housing 10 and the cover 30.

Next, the shield shell 60 is attached to the housing 10.

First, the upper shield shell 61 of the shield shell 60 is attached from the rear side to cover the housing 10 to which the cover 30 is assembled.

At this time, an inner surface of the peripheral wall 65 of the housing 10 is inserted into and guided by the plurality of ribs 17 projecting from the outer peripheral surface 10a of the housing 10 while contacting the ribs 17 in a sliding manner.

Next, the lower shield shell 62 of the shield shell 60 is attached from the lower side to cover the electric wire introduction portion 12 of the housing 10.

The upper shield shell 61 and the lower shield shell 62 are attached to the housing 10, and the through holes 69 of the upper shield shell 61 and the screw holes of the lower shield shell 62 communicate with each other. Thereafter, the upper shield shell 61 and the lower shield shell 62 are fixed to the housing 10 by inserting attachment screws (not illustrated) into the through holes 69 and screwing the attachment screws into the screw holes.

The upper shield shell 61 and the lower shield shell 62 are electrically connected to each other via the attachment screws. Further, one end of the braid of the shielded electric wires 44 is electrically connected to the shield shell 60 by the shield terminal 43 of the terminal-equipped electric wire 40.

In the connector 1 having the above structure, the fitting portion 11 is fitted to a counterpart connector provided in a case such as an inverter or a motor. Accordingly, the tab terminal 41 in the fitting portion 11 is inserted into and electrically connected to the electrical connection portion of the counterpart terminal. When the connector 1 is fitted to the counterpart connector, the packing 24 is brought into close contact with a housing of the counterpart connector. Thus, a fitting portion between the connector 1 and the counterpart connector is sealed.

When the connector 1 is fitted to the counterpart connector, bolts (not illustrated) inserted into the hole portions of the fixing pieces 67 of the upper shield shell 61 and the hole portions of the fixing pieces 64 of the lower shield shell 62 are screwed into screw holes (not illustrated) formed in the case. Thus, the connector 1 is pushed toward the counterpart connector by a fastening force of the bolt. Accordingly, the connector 1 can be easily fitted to the counterpart connector.

Further, since the fixing pieces 67 of the upper shield shell 61 and the fixing pieces 64 of the lower shield shell 62 are fastened by bolts, the shield shell 60 is electrically connected to the case. Accordingly, the connector 1 is covered with the shield shell 60 fixed to the case, and a good electromagnetic shielding effect is obtained.

When the connector 1 is mounted on a vehicle, the inner peripheral side seal surface 16a of the opening 16 of the housing 10 is creep-deformed outward by a reaction force of the seal member 50 under a high-temperature environment. As illustrated in FIGS. 8 and 9, a plurality of reinforcing ribs 19 are disposed at an inside corner of the accommodating portion 13, and deformation of the opening 16 in an expansion direction can be prevented.

When an internal pressure is applied to the inside of the housing 10 under the high-temperature environment, the seal member 50 falls off the inner peripheral side seal surface 16a of the opening 16 and the outer peripheral side seal surface 31 of the cover 30. As illustrated in FIGS. 8 and 9, since the end in the extension direction of the reinforcing rib 19 facing the seal member 50 comes into contact with the seal member 50 that moves in a falling direction to restrict the movement, the reinforcing rib 19 can prevent the seal member 50 from falling off.

In the connector 1 according to the present embodiment, it is possible to prevent the creep deformation of the inner peripheral side seal surface 16a of the opening 16 to the outside and to prevent the seal member 50 from falling off only by the reinforcing ribs 19 provided in the housing 10. Therefore, in order to prevent the seal member from falling off, it is not necessary to provide a through hole of a cover and a locking projection of a seal member as in the related art, and a size of the connector 1 can be prevented and the size can be reduced.

As a result, in the connector 1 according to the present embodiment, it is possible to prevent a decrease in a sealing pressure of the seal member 50, and it is possible to secure a good waterproof seal.

Therefore, according to the present disclosure, it is possible to provide a compact connector 1 capable of preventing deformation of the housing 10 and preventing the seal member 50 from falling off.

In the connector 1 according to the present embodiment, as illustrated in FIG. 5, the seal member 50 includes the annular seal body portion 51, the outer lip 51a provided on the outer peripheral surface of the seal body portion 51, and the inner lip 51b provided on the inner peripheral surface of the seal body portion 51. As illustrated in FIG. 9, the reinforcing rib 19 has a contact surface 19a on the end in the extension direction that is parallel to a width direction end surface 51c of the seal body portion 51.
when the end in the extension direction of the reinforcing rib 19 comes into contact with the seal member 50 that moves in a falling direction to restrict the movement, the contact surface 19a parallel to the width direction end surface 51c of the seal body portion 51 comes into contact. Therefore, it is possible to prevent the end in the extension direction of the reinforcing rib 19 from locally deforming or damaging the seal member 50 in contact therewith.

The present disclosure is not limited to the above embodiments, and can be appropriately modified, improved, and the like. In addition, materials, shapes, sizes, numbers, arrangement positions, or the like of components in the above embodiment are freely selected and are not limited as long as the present disclosure can be implemented.

For example, in the above embodiment, the connector 1 according to the present embodiment has been described by taking a shielded connector as an example, but the present disclosure is not limited thereto, and can be applied to various connectors in which a gap between an opening of a housing and a cover needs to be sealed with a seal member.

Here, features of the embodiment of the connector according to the present disclosure described above are briefly summarized and listed in the following first and second aspects.

According to the first aspect, a connector (1) includes: a housing (10) having a fitting portion (11) configured to be fitted to a counterpart connector; a cover (30) assembled to an opening (16) opposite to the fitting portion (11); an annular seal member (50) configured to seal a gap between an inner peripheral side seal surface (16a) of the opening (16) and an outer peripheral side seal surface (31) of the cover (30); and a plurality of reinforcing ribs (19) disposed at predetermined intervals along an inner peripheral surface (10b) of the housing (10) and extending along an assembling direction of the cover (30), the inner peripheral surface (10b) of the housing (10) being located behind the inner peripheral side seal surface (16a) of the opening (16). When the cover (30) is assembled to the opening (16), an end in an extension direction of the reinforcing ribs (19) on an opening end side of the opening (16) faces the seal member (50), thereby preventing the seal member (50) from falling off from the inner peripheral side seal surface (16a) and the outer peripheral side seal surface (31).

According to the connector (1) having a configuration of the above first aspect, the inner peripheral side seal surface (16a) of the opening (16) can be creep-deformed outward, and the seal member (50) can be prevented from falling off only by the reinforcing ribs (19) provided in the housing (10). Therefore, in order to prevent the seal member from falling off, it is not necessary to provide a through hole of a cover and a locking projection of a seal member as in the related art, and a size of the connector (1) can be prevented and the size can be reduced.

According to the second aspect, in the connector (1) according to the first aspect, the seal member (50) includes an annular seal body portion (51), an outer lip (51a) provided on an outer peripheral surface of the seal body portion (51), and an inner lip (51b) provided on an inner peripheral surface of the seal body portion (51). The reinforcing ribs (19) have a contact surface (19a) on the end in the extension direction, the contact surface being parallel to a width direction end surface (51c) of the seal body portion (51).

According to the connector (1) having the configuration of the above second aspect, when the end in the extension direction of the reinforcing rib (19) comes into contact with the seal member (50) that moves in a falling direction to restrict the movement, the contact surface (19a) parallel to the width direction end surface (51c) of the seal body portion (51) comes into contact. Therefore, it is possible to prevent the end in the extension direction of the reinforcing rib (19) from locally deforming or damaging the seal member (50) in contact therewith.

What is claimed is:

1. A connector comprising:
a housing having a fitting portion configured to be fitted to a counterpart connector;
a cover assembled to an opening opposite to the fitting portion;
an annular seal member configured to seal a gap between an inner peripheral side seal surface of the opening and an outer peripheral side seal surface of the cover; and
a plurality of reinforcing ribs disposed at predetermined intervals along an inner peripheral surface of the housing and extending along an assembling direction of the cover, the inner peripheral surface of the housing being located behind the inner peripheral side seal surface of the opening, wherein
when the cover is assembled to the opening, an end in an extension direction of the reinforcing ribs on an opening end side of the opening faces the seal member, thereby preventing the seal member from falling off from the inner peripheral side seal surface and the outer peripheral side seal surface.

2. The connector according to claim 1, wherein
the seal member includes an annular seal body portion, an outer lip provided on an outer peripheral surface of the seal body portion, and an inner lip provided on an inner peripheral surface of the seal body portion, and
the reinforcing ribs have a contact surface on the end in the extension direction, the contact surface being parallel to a width direction end surface of the seal body portion.
